(19) United States
(12) Patent Application Publication
(10) Pub. No.: US 2018/0032354 A1
(43) Pub. Date: Feb. 1, 2018

(54) INFORMATION PROCESSING APPARATUS, INFORMATION PROCESSING SYSTEM, COMPUTER-READABLE NON-TRANSITORY RECORDING MEDIUM HAVING A PROGRAM STORED THEREIN, AND INFORMATION PROCESSING METHOD

(71) Applicant: FUJITSU LIMITED, Kawasaki-shi (JP)

(72) Inventor: Shigeyoshi Yamasaki, Hachiouji (JP)

(73) Assignee: FUJITSU LIMITED, Kawasaki-shi, Kanagawa (JP)

(21) Appl. No.: 15/632,446

(22) Filed: Jun. 26, 2017

(30) Foreign Application Priority Data
Jul. 29, 2016 (JP) 2016-150086

(51) Int. Cl. G06F 9/445

(52) U.S. Cl. CPC G06F 9/44505; G06F 8/60; G06F 9/45558

(57) ABSTRACT

An information processing apparatus includes a processor configured to collect software information indicating first software deployed to a virtual machine and a parameter value set in the first software, and generate parameter information indicating a value which is settable as a parameter of the first software based on the software information and the parameter value which are collected.

### CROSS-REFERENCE TO RELATED APPLICATION

This application is based upon and claims the benefit of priority of the prior Japanese Patent application No. 2016-150086, filed on Jul. 29, 2016, the entire contents of which are incorporated herein by reference.

### FIELD

The embodiments discussed herein are related to information processing apparatus, an information processing system, a computer-readable non-transitory recording medium having a program stored therein, and an information processing method.

### BACKGROUND

Software deployed to the cloud (for example, an “ROR”) can create templates of ICT resources such as an operating system (OS), a memory, a disk, a network, and the like as infrastructure resources in a data center. The “ROR” is an abbreviation for resource orchestrator. The “ICT” is an abbreviation for information and communication technology, and the “ICT resources” are hereinafter referred to simply as “resources.” Hereinafter, “software such as ROR deployed to the cloud” is also referred to as “cloud deployment software.”

A cloud administrators can easily deploy (that is, “allocate” or “provide”) resources to the users who use the cloud by using the template.

The cloud deployment software extracts a virtual server including application software which is actually operating as a system image. Further, the cloud deployment software can use the extracted system image as a template of a logical platform having a business system as a unit.

The user can deploy software to the cloud simultaneously in addition to the resources by using the template including the system image. In other words, the user can easily deploy the business system as a virtual machine by using the template.

Patent Document 1: Japanese Laid-open Patent Publication No. 2014-99059

Patent Document 2: Japanese Laid-open Patent Publication No. 2013-97394

Patent Document 3: Japanese National Publication of International Patent Application No. 2014-514659

However, when the business system is simply deployed by using template, since parameters of software constituting the business system are not set, the user is unable to use the business system.

Accordingly, a time in which the user is unable to use the business system is continued although the deployment of the business system is completed.

### SUMMARY

To this end, an information processing apparatus includes a processor configured to collect software information indicating first software deployed to a virtual machine and a parameter value set in the first software, and generate parameter information indicating a value which is settable as a parameter of the first software based on the software information and the parameter value which are collected.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

### BRIEF DESCRIPTION OF DRAWINGS

FIG. 1 is a diagram schematically illustrating a configuration of an information processing system as an example of an embodiment;

FIG. 2 is a diagram illustrating a logical platform (L-platform) template used in an information processing system as an example of an embodiment;

FIG. 3 is a diagram schematically illustrating a software configuration of an information processing system as an example of an embodiment;

FIG. 4 is a diagram schematically illustrating a software configuration of an information processing system as an example of an embodiment;

FIG. 5 is a diagram schematically illustrating a hardware configuration of each of a business server and a management server as an example of an embodiment;

FIG. 6 is a diagram schematically illustrating a functional configuration of a central processing unit (CPU) installed in a business server as an example of an embodiment;

FIG. 7 is a diagram schematically illustrating a functional configuration of a CPU installed in a management server as an example of an embodiment;

FIG. 8 is a diagram illustrating an attached file transmission process in an information processing system as an example of an embodiment;

FIG. 9 is a diagram illustrating an attached file in an information processing system as an example of an embodiment;

FIG. 10 is a diagram illustrating a parameter collection process in an information processing system as an example of an embodiment;

FIG. 11 is a diagram for describing a process of generating a parameter information extensible markup language (XML) file in an information processing system as an example of an embodiment;

FIG. 12 is a diagram for describing a parameter setting process in an information processing system as an example of an embodiment;

FIG. 13 is a diagram illustrating a parameter setting database (DB) in an information processing system as an example of an embodiment;

FIG. 14 is a diagram illustrating transition of a parameter setting state in an information processing system as an example of an embodiment;

FIG. 15 is a diagram for describing a startup script generation process in an information processing system as an example of an embodiment;

FIG. 16 is a diagram illustrating parameter setting definition information and a startup script of a parameter setting script in an information processing system as an example of an embodiment;

FIG. 17 is a diagram illustrating software execution processing in an information processing system as an example of an embodiment;

FIG. 18 is a diagram illustrating the details of a process of collecting a parameter information XML file in an information processing system as an example of an embodiment; and

FIG. 19 is a diagram illustrating parameter collection definition information and a parameter information XML file in an information processing system as an example of an embodiment.

### DESCRIPTION OF EMBODIMENTS

Hereinafter, an exemplary embodiment will be described with reference to the appended drawings. However, the following embodiment is merely an example and not intended to exclude the application of various modifications or techniques which are not explicitly described in the embodiment. In other words, the present embodiment can be implemented with various modifications within the scope not departing from the gist thereof.

Further, the respective drawings are not intended to include only components illustrated in the drawing and can include other functions or the like.

Hereinafter, in the drawings, the same parts are denoted by the same reference numerals, and description thereof will be omitted.

### [A] Example of First Embodiment

[A-1] System Configuration

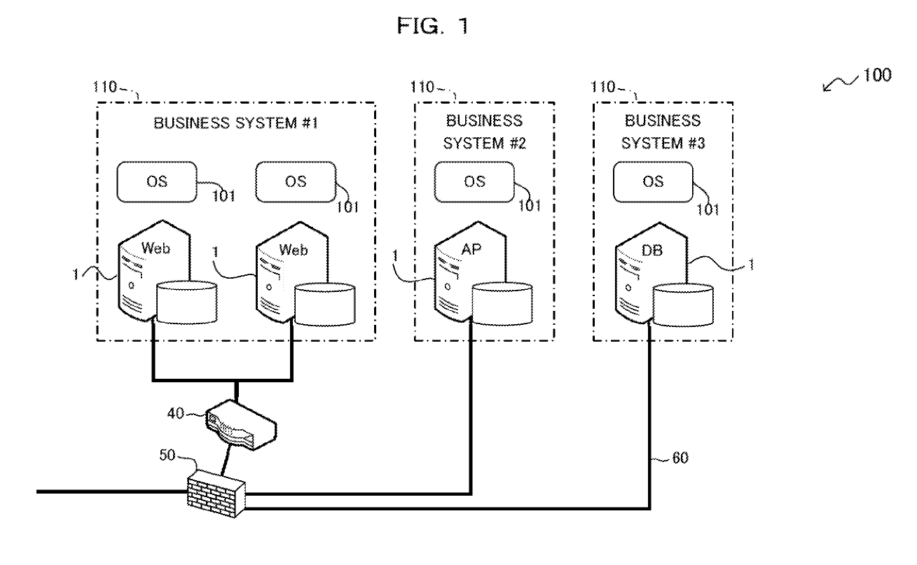

FIG. 1 is a diagram schematically illustrating a configuration of an information processing system 100 as an example of an embodiment.

The information processing system 100 includes a plurality of business server 1 (four business servers 1 in the illustrated example), a load balancer 40, and a firewall 50 as illustrated in FIG. 1. The business servers 1, the load balancer 40, and the firewall 50 are connected via, for example, a business local area network (LAN) 60 to which a virtual local area network identifier (VLAN ID) is allocated.

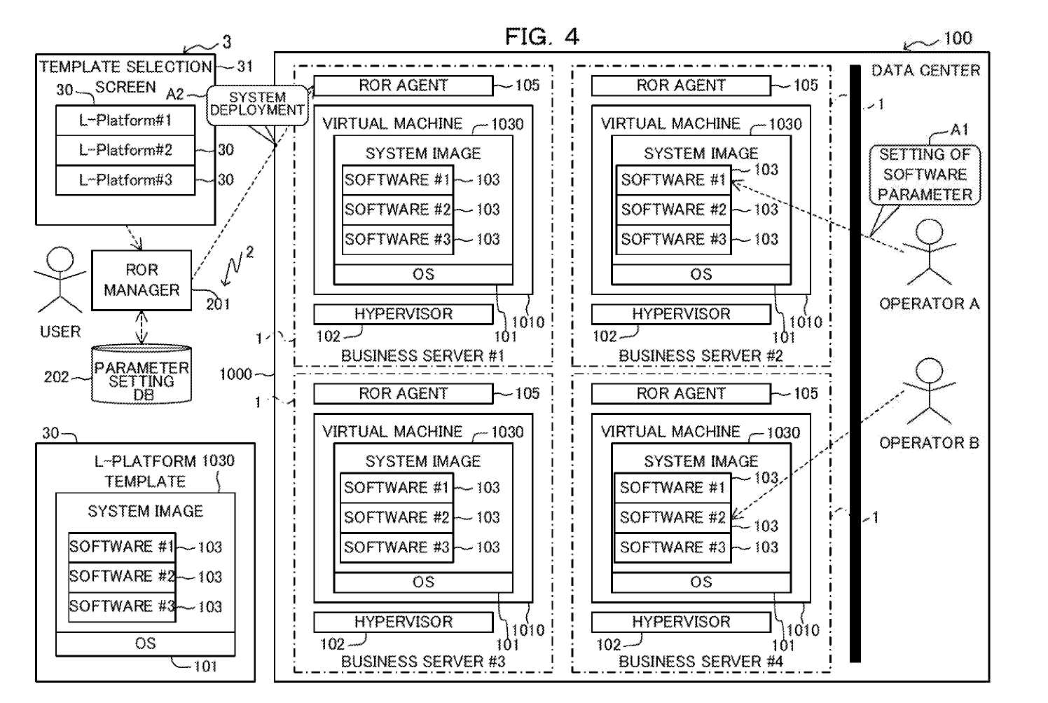

One or more business servers 1 constitute a business system 110 (business systems #1 to #3). For example, one unit of the business system 110 is a set of the business server 1 which can collectively perform creation, deletion, activation, and stop of a virtual machine 1010 (which will be described later with reference to FIG. 4 or the like) and various definitions.

In the example illustrated in FIG. 1, the business system #1 is provided with two business servers 1, the business system #2 is provided with one business server 1, and the business system #3 is provided with one business server 1.

The information processing system 100 is an example of a logical platform of a three-layer system.

In the example illustrated in FIG. 1, each of the two business servers 1 of the business system #1 is a web server, the business server 1 of the business system #2 is an application (AP) server, and the business server 1 of the business system #1 is a DB Server. The web server and the AP server may be a virtual server, and the DB server may be a physical server.

An OS 101 is developed to each business server 1. The OS 101 is system software that implements a basic function such as management of hardware of the business server 1.

The load balancer 40 is a device that distributes the load to a plurality of business servers 1 so that an access load is not concentrated on a specific business server 1. The load balancer 40 may be a network device or a virtual network device.

In the example illustrated in FIG. 1, the load balancer 40 is installed between the two business servers 1 (that is, the “web server”) of the business system #1 and the firewall 50, and distributes the load to the two web servers.

The firewall 50 has a function of blocking specific communication. The firewall 50 may be a network device or a virtual network device.

In the example illustrated in FIG. 1, the firewall 50 blocks specific communication between each of the business servers 1 and a network outside the information processing system 100.

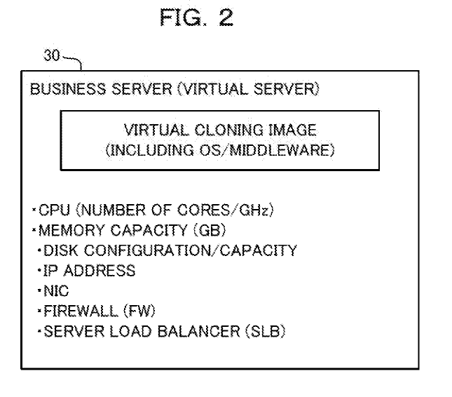

FIG. 2 is a diagram illustrating an L-platform template used in the information processing system 100 as an example of an embodiment.

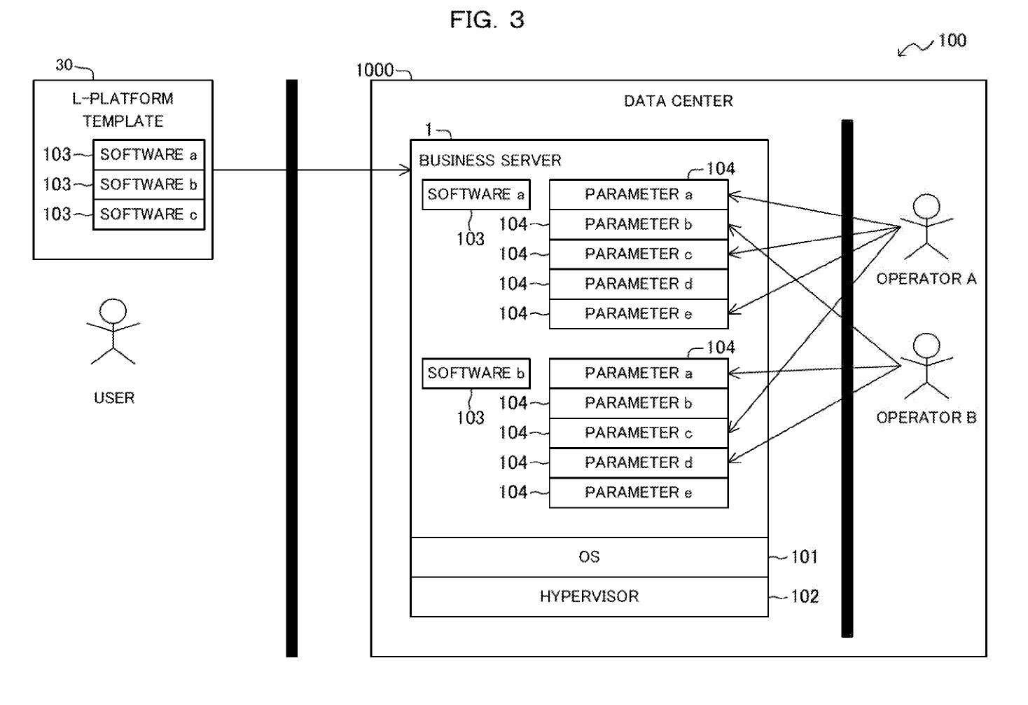

The user of the cloud deployment software simultaneously deploys the software 103 (which will be described later with reference to FIG. 3 or the like) to the cloud in addition to the resources by using an L-platform template 30 including the system image as illustrated in FIG. 2. Hereinafter, the “L-platform template 30” is also referred to simply as a “template 30.”

For example, the template 30 has information related to the number of cores and a frequency (GHz) of the CPU, a memory capacity (GB), a disk configuration and a capacity, and an Internet protocol (IP) address in the business server 1. The template 30 further includes, for example, information related to a network interface card (NIC), a firewall (FW), and a server load balancer (SLB) in the business server 1. The template 30 further includes a virtual cloning image including an OS and middleware.

FIG. 3 is a diagram schematically illustrating a software configuration of the information processing system 100 as an example of an embodiment.

The information processing system 100 includes a data center 1000 as illustrated in FIG. 3. The data center 1000 includes a business server 1.

The OS 101, the hypervisor 102, and one or more software 103 (two pieces of software, that is, software a and b in the illustrated example) are deployed to the business server 1.

The hypervisor 102 is a control program for realizing the virtual machine 1010 (which will be described later with reference to FIG. 4).

The software 103 executes information processing requested by the user.

The user instructs deployment of the software 103 in the business server 1 in the data center 1000 by using the template 30. In the example illustrated in FIG. 3, the user instructs the deployment of software a, b, and c in the business server 1 in the data center 1000 by using template 30. In FIG. 3, the software c is not illustrated in the business server 1 of the data center 1000.

In data center 1000, one or more operators (two operators, that is, operators A and B in the example illustrated in FIG. 3) are at work. The operator sets parameters 104 of the software 103 (parameters a to e) to be deployed to the business server 1.

In the example illustrated in FIG. 3, the operator A sets the parameters a, c, and e of the software a and the parameter c of the software b. In the example illustrated in FIG. 3, the operator B sets the parameter b of the software a and the parameters a and d of the software b.

FIG. 4 is a diagram schematically illustrating a software configuration of the information processing system 100 as an example of an embodiment.

The information processing system 100 includes the data center 1000, management server 2, and terminal 3 as illustrated in FIG. 4.

The data center 1000 includes one or more business servers 1 (four business servers, that is, business servers #1 to #4 in the illustrated example) as illustrated in FIG.

4.

Each of the business servers 1 develops an ROR agent 105, the virtual machine 1010, and the hypervisor 102.

The virtual machine 1010 develops the OS 101 and a system image 1030.

The system image 1030 develops one or more pieces of software 103 (three pieces of software, that is, software #1 to #3 in the example illustrated in FIG. 4).

The ROR agent 105 performs collection of the parameters 104 which are set in the software 103 by the operator and a setting of the collected parameters 104 for the software 103.

In the example illustrated in FIG. 4, the operator A sets the parameters 104 of the software #1 of the business server #2 (see reference numeral A1), and the operator B sets the parameters 104 of the software #2 of the business server #4.

The user selects the template 30 (L-platforms #1 to #3) to be used for the deployment of the software 103 from a template selection screen 31 displayed on the terminal 3.

The terminal 3 instructs the ROR agent 105 to perform system deployment of the software 103 included in the template 30 via an ROR manager 201 (see A2).

The management server 2 includes an ROR manager 201 and a parameter setting DB 202.

The parameter setting DB 202 stores information related to the parameters 104 collected by the ROR manager 201.

The ROR manager 201 determines whether or not the information related to the parameters 104 of the software 103 for which the instruction to perform the system deployment is given by the terminal 3 is stored in the parameter setting DB 202. When the information related to the parameters 104 is stored in the parameter setting DB 202, the ROR manager 201 reads the information related to the parameters 104 from the parameter setting DB 202 and transmits the information to the ROR agent 105.

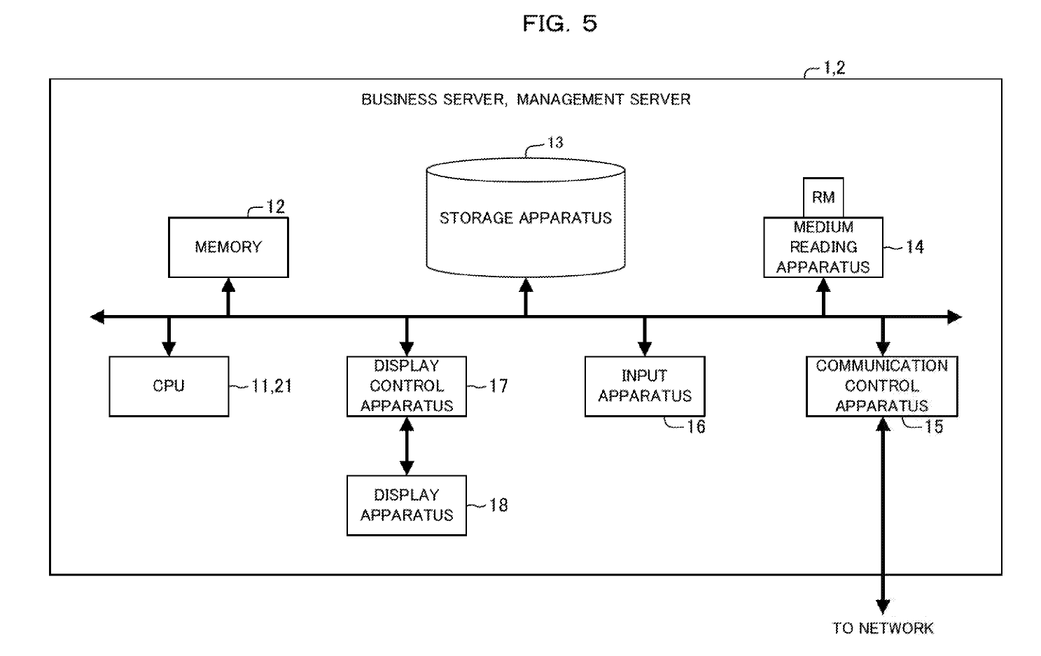

FIG. 5 is a diagram schematically illustrating a hardware configuration of each of the business server 1 and the management server 2 as an example of an embodiment.

The business server 1 includes a CPU 11, a memory 12, a storage apparatus 13, a medium reading apparatus 14, a communication control apparatus 15, an input apparatus 16, a display control apparatus 17, and a display apparatus 18. The management server 2 includes a CPU 21, a memory 12, a storage apparatus 13, a medium reading apparatus 14, a communication control apparatus 15, an input apparatus 16, a display control apparatus 17, and a display apparatus 18.

The communication control apparatus 15 is an interface that communicably connecting the business server 1 or the management server 2 with a network.

The input apparatus 16 is, for example, a mouse, a trackball, or a keyboard, and the operator performs various input operations through the input apparatus 16.

The display control apparatus 17 controls the display apparatus 18 based on an instruction given from the CPU 11 or 21.

The display apparatus 18 is a liquid crystal display, a cathode ray tube (CRT), an electronic paper display, or the like and displays various kinds of information to the operator or the like.

The input apparatus 16 and the display apparatus 18 may be combined, and for example, a touch panel may be used.

The medium reading apparatus 14 is configured so that the recording medium RM can be loaded. The medium reading apparatus 14 is configured to be capable of reading information recorded in the recording medium RM in a state in which the recording medium RM is loaded. In the present example, the recording medium RM has portability. The recording medium RM is a computer-readable recording medium, and examples of the recording medium RM include a flexible disk, a CD (a CD-ROM, a CD-R, a CD-RW, or the like), a DVD (a DVD-ROM, a DVD-RAM, a DVD-R, a DVD+R, a DVD-RW, DVD+RW, a HD DVD, or the like), a Blu-ray disc, a magnetic disk, an optical disk, a magneto-optical disk, or a semiconductor memory.

The storage apparatus 13 is a device that stores data in a readable and writable manner, and for example, a hard disk drive (HDD), a solid state drive (SSD), or a storage class memory (SCM) may be used.

The storage apparatus 13 of the business server 1 stores, for example, data related to the software 103. The storage apparatus 13 of the management server 2 stores, for example, the parameter setting DB 202. The storage apparatus 13 of the management server 2 is an example of a storage unit.

For example, the memory 12 is a storage apparatus including at least one of a read only memory (ROM) and a random access memory (RAM). A program such as a basic input/output system (BIOS) may be written in the ROM of the memory 12. The software program of the memory 12 may be appropriately read by the CPU 11 or 21. Further, the RAM of the memory 12 may be used as a primary recording memory or a working memory.

The CPUs 11 and 21 are processing devices that perform various controls and operations, and implement various functions by executing the OS 101 and the programs stored in the memory 12.

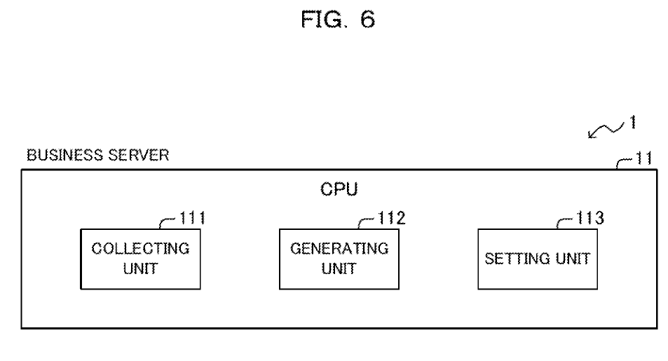

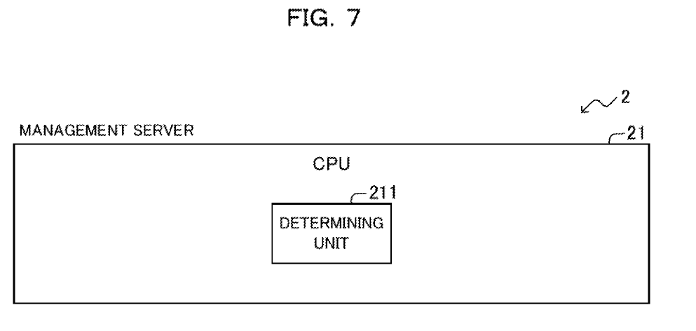

FIG. 6 is a diagram schematically illustrating a functional configuration of the CPU 11 installed in the business server 1 as an example of an embodiment. FIG. 7 is a diagram schematically illustrating a functional configuration of the CPU 21 installed in the management server 2 as an example of an embodiment.

The CPU 11 of the business server 1 functions as a collecting unit 111, a generating unit 112, and a setting unit 113 as illustrated in FIG. 6. Further, the CPU 21 of the management server 2 functions as a determining unit 211 as illustrated in FIG. 7.

For example, programs for implementing the functions illustrated in FIGS. 6 and 7 are provided in a form recorded in the recording medium RM. A computer reads the programs from the recording medium RM via the medium reading apparatus 14 and transfers the programs to an internal storage apparatus or an external storage apparatus for storage and use. Further, the program may be recorded in a storage apparatus (a recording medium) such as a magnetic disk, an optical disk, a magneto-optical disk, or the like and provided from the storage apparatus to the computer via a communication path.

When the functions illustrated in FIGS. 6 and 7 are implemented, the programs stored in the internal storage apparatus (the memory 12 in the present embodiment) are executed by a microprocessor of the computer (the CPU 11 or 21 in the present embodiment). At this time, the computer may read and execute the program recorded in the recording medium.

The CPU 11 controls an operation of the entire business server 1, and the CPU 21 controls an operation of the entire management server 2. An apparatus for controlling the operation of the entire business server 1 or the entire management server 2 is not limited to the CPU 11 or 21 but may be any one of a micro processing unit (MPU), a Digital Signal Processor (DSP), an application specific integrated circuit (ASIC), a programmable logic device (PLD), and a field programmable gate array (FPGA). Further, an apparatus for controlling the operation of the entire business server 1 or the entire management server 2 may be a combination of two or more of a CPU, an MPU, a DSP, an ASIC, a PLD, and a FPGA.

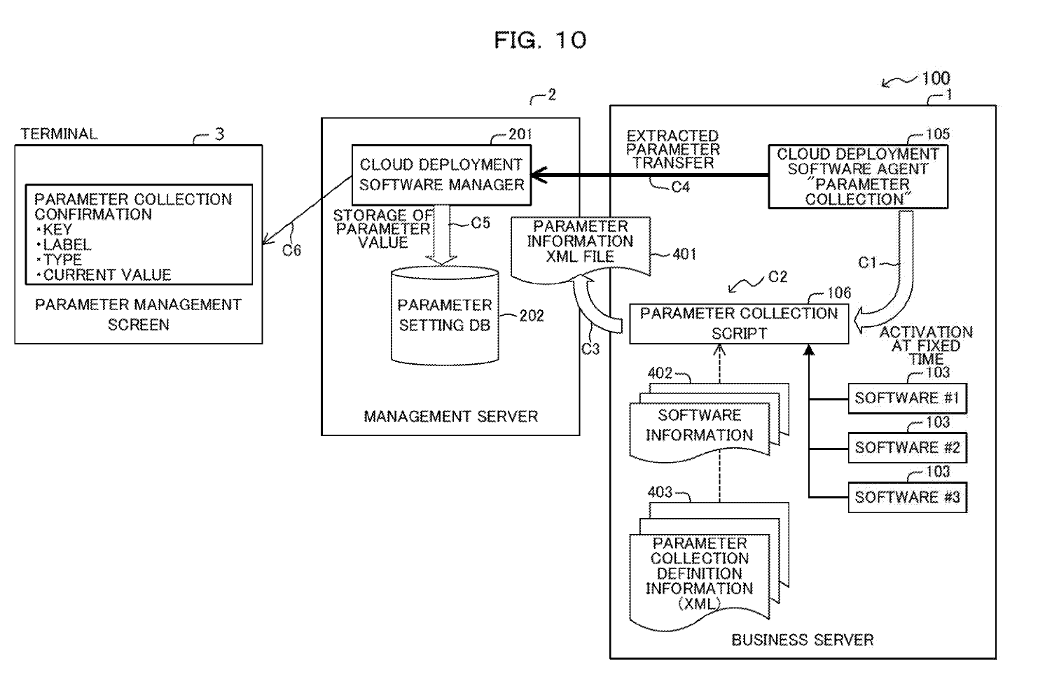

The collecting unit 111 illustrated in FIG. 6 collects software information 402 (which will be described later with reference to FIG. 10 or the like) indicating the software 103 deployed to the virtual machine 1010. Further, the collecting unit 111 collects parameter collection definition information 403 (which will be described later with reference to FIG. 10 or the like) including information related to the parameters 104 set in the software 103 by the operator.

The generating unit 112 generates a parameter information XML file 401 (which will be described later with reference to FIG. 10 or the like) indicating values which are settable as the parameters 104 of the software 103. The generating unit 112 generates the parameter information XML file 401 on the basis of the software information 402 and the parameter collection definition information 403 collected by the collecting unit 111.

Accordingly, the software 103 can be efficiently deployed to the virtual machine 1010. Specifically, it is possible to learn a setting of the parameters 104 which is performed manually when a deployment request is repeatedly transmitted to a plurality of business servers 1 by using the template 30 of the same logical platform in which a clone image of the virtual machine 1010 in which it is desired to be deployed is captured.

When both a first condition and a second condition are satisfied, the setting unit 113 sets software 103 to be newly deployed to the virtual machine 1010 by using the parameter information XML file 401 generated by the generating unit 112.

Here, the first condition is that information indicating the software 103 included in the parameter information XML file 401 generated by the generating unit 112 coincides with information indicating the software 103 to be newly deployed to the virtual machine 1010. The second condition is that information indicating the parameters 104 included in the parameter information XML file 401 generated by the generating unit 112 coincides with the parameters 104 set in the software 103 to be newly deployed to the virtual machine 1010.

Accordingly, the setting of the parameters 104 for the software 103 is automated, and the number of working processes by the operator can be reduced. For example, when the user makes the deployment request by using the template 30 having the clone image of the virtual machine 1010 including monitoring software, works that are dealt with manually such as setting of monitoring parameters of the monitoring software are reduced. Further, when the collection of the parameters 104 is repeatedly performed, the setting of all the parameters 104 can be finally automated.

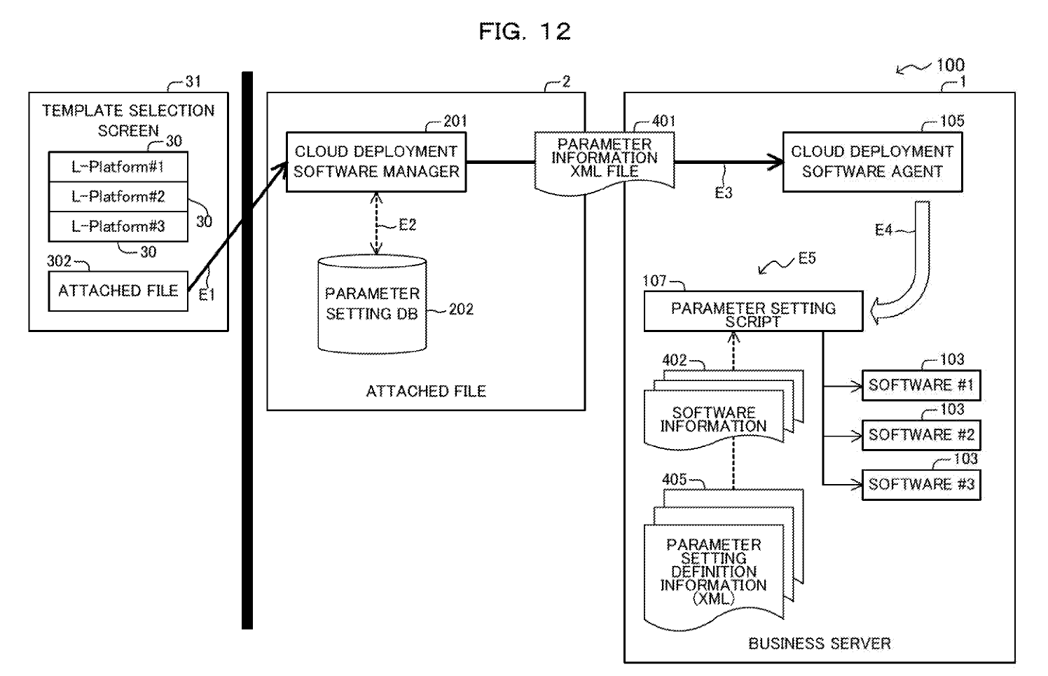

The setting unit 113 sets the software 103 to be newly deployed to the virtual machine 1010 on the basis of the software information 402 collected by the collecting unit 111 and parameter setting definition information 405 (which will be described later with reference to FIG. 12 or the like). Here, the parameter setting definition information 405 is generated on the basis of the parameter collection definition information 403 collected by the collecting unit 111.

The parameter information XML file 401 generated by the generating unit 112 is stored in the storage apparatus 13 of the management server 2.

The determining unit 211 illustrated in FIG. 7 determines whether or not both the first condition and the second condition are satisfied.

Here, the first condition is that the information indicating the software 103 included in the parameter information XML file 401 stored in the storage apparatus 13 of the management server 2 coincides with the information indicating the software 103 newly deployed to the virtual machine 1010. The second condition is that the information indicating the parameters 104 included in the parameter information XML file 401 stored in the storage apparatus 13 of the management server 2 coincides with the parameters 104 to be set in the software 103 to be newly deployed to the virtual machine 1010.

A determination result by the determining unit 211 is used for a setting of the software 103 by the setting unit 113 of the business server 1.

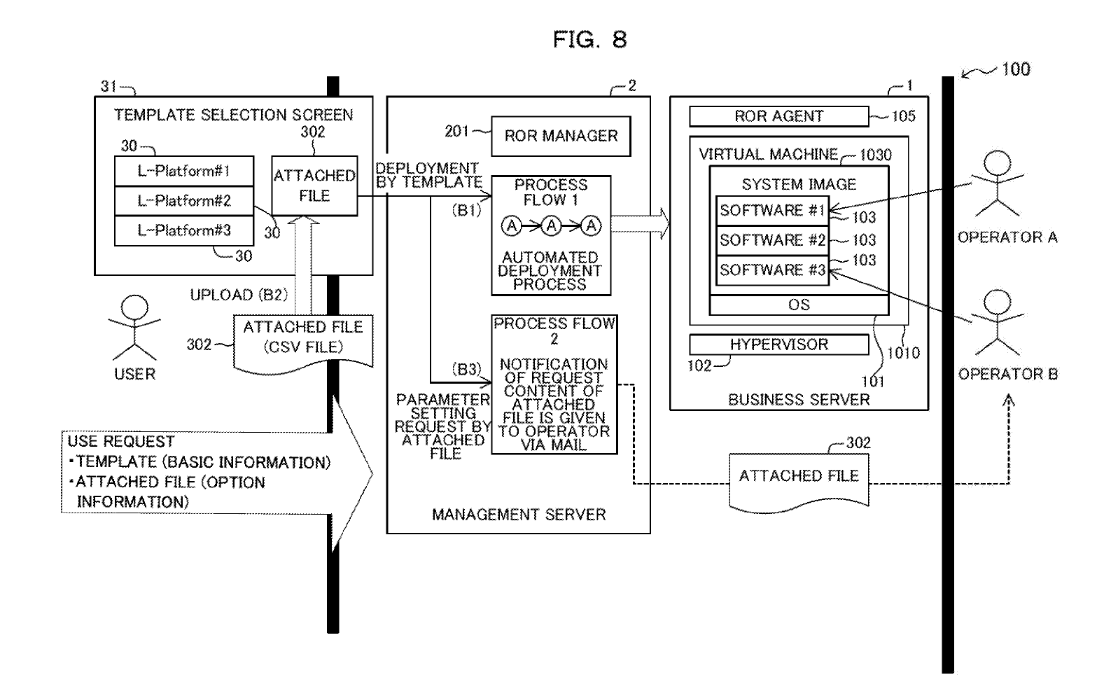

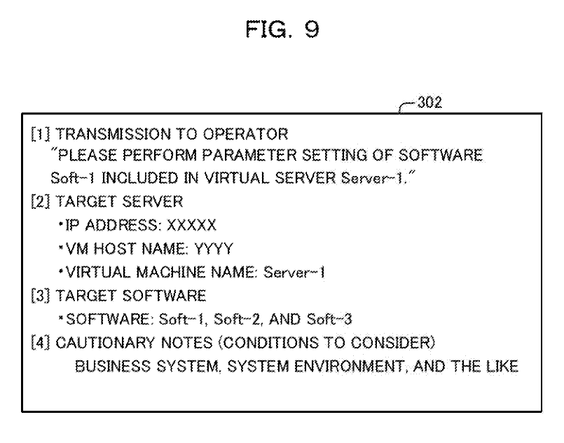

FIG. 8 is a diagram for describing a transmission process of an attached file 302 in the information processing system 100 as an example of an embodiment. FIG. 9 is a diagram illustrating the attached file 302 in the information processing system 100 as an example of an embodiment.

When the user makes a request for using the software 103, in addition to the template 30 (which may be also referred to as “basic information”) illustrated in FIG. 3 or the like, the attached file 302 (which may be also referred to as “option information”) is transmitted from the terminal 3 to the management server 2 as illustrated in FIG. 8.

The attached file 302 is, for example, a comma-separated values (CSV) file. For example, [1] A message for the operator, [2] a target server, [3] target software, and

a cautionary note are included in the attached file 302 as illustrated in FIG. 9.

The user selects the template 30 (the L-platforms #1 to #3) from the template selection screen 31 of the terminal 3 as illustrated in FIG. 8.

The terminal 3 gives an instruction to perform the deployment of the software 103 by the template 30 by transmitting the selected template 30 to the management server 2 (see reference numeral B1).

The ROR manager 201 of the management server 2 deploys the software 103 (the “software #1 to #3” in the example illustrated in FIG. 8) to the business server 1 through an automated deployment process (see symbols “A” of “process flow 1”).

The user uploads the attached file 302 to the terminal 3 (see reference numeral B2).

The terminal 3 gives an instruction to make a request of setting the parameters 104 by the attached file 302 by transmitting the uploaded attached file 302 to the management server 2 (see reference numeral B3).

For example, the management server 2 gives a notification indicating the request content of the attached file 302 to the operator via an e-mail (see “process flow 2”).

The operator sets the software 103 on the basis of the request content of the attached file 302 notified from the management server 2. In the example illustrated in FIG. 8, the operator A sets the software #1, and the operator B sets the software #3.

FIG. 10 is a diagram for describing a process of collecting the parameters 104 in the information processing system 100 as an example of an embodiment.

The ROR agent 105 (referred to as a “cloud deployment software agent”) collects the parameters 104 set by the operator. The ROR agent 105 generates the parameter information XML file 401 in accordance with the collected parameters 104 and stores the parameter information XML file 401 in the parameter setting DB 202 of the management server 2.

The ROR agent 105 activates the process of collecting the parameters 104 at a predetermined time (for example, at midnight every day) (see reference numeral C1).

The ROR agent 105 calls a parameter collection script 106. Then, the ROR agent 105 reads out the parameters 104 from the target software 103 with reference to the software information 402 (see reference numeral C2).

The ROR agent 105 outputs the parameters 104 to the parameter information XML file 401 in a format specified by the parameter collection definition information 403 (see reference numeral C3).

The ROR agent 105 transfers the generated parameter information XML file 401 to the ROR manager 201 of the management server 2 (referred to as a “cloud deployment software manager”) (see reference numeral C4).

In other words, the ROR agent 105 corresponds to the collecting unit 111 and the generating unit 112 illustrated in FIG. 6.

The ROR manager 201 stores the transferred parameter information XML file 401 in the parameter setting DB 202 (see reference numeral C5).

The ROR manager 201 causes information related to the parameters collected in the business server 1 to be displayed on the parameter management screen of the terminal 3 (see reference numeral C6). For example, keys, labels, types, and current values are displayed on the parameter management screen.

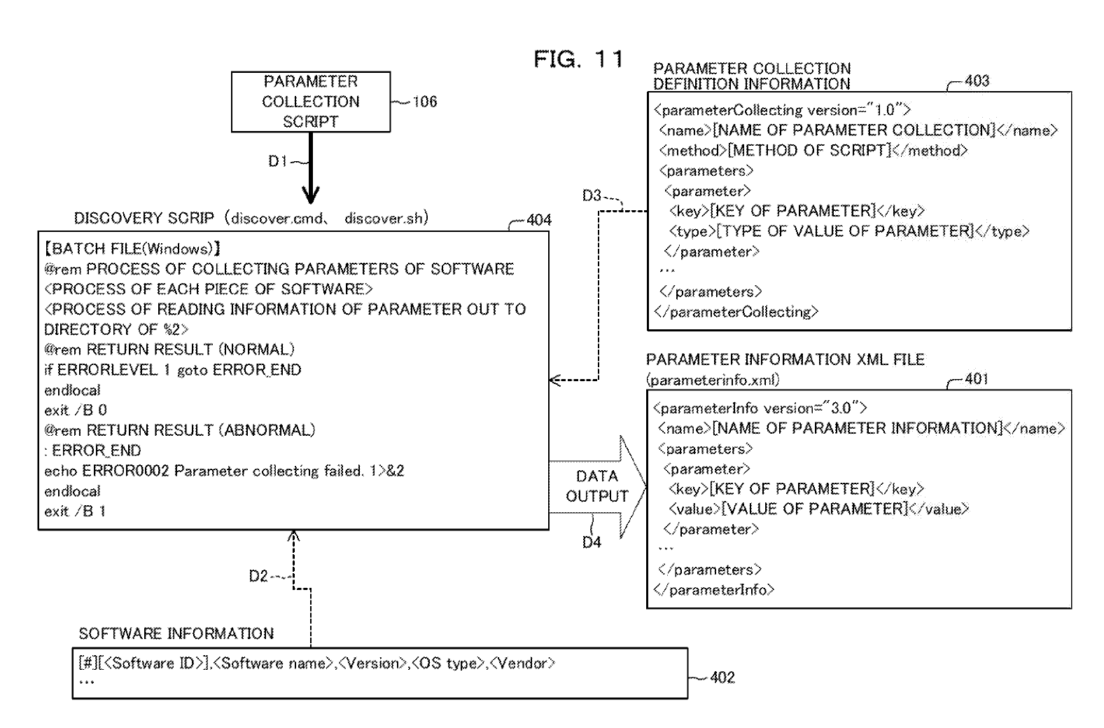

FIG. 11 is a diagram for describing a process of generating the parameter information XML file 401 in the information processing system 100 as an example of an embodiment.

The parameter collection script 106 calls a discovery script 404 (see reference numeral D 1).

The discovery script 404 reads the parameters 104 from the target software 103 with reference to the software information 402 and the parameter collection definition information 403 (see reference numerals D2 and D3).

The software information 402 includes, for example, information related to a software ID, a software name, a version, and an OS type. The software information 402 is, for example, information which is uniquely identified by a combination of a software name, a version, and an OS type. In other words, the software information 402 has a function as an identification key of the software 103.

The parameter collection definition information 403 is a file defining configuration information of the parameter collected from the software 103. A parameter list (that is, “key name and type”) or a method of a script is designated in the parameter collection definition information 403. Further, a Boolean (Boolean value), a number (numeric value), a string (character string), a string array (array of character strings), and a map may be designated in the parameter collection definition information 403.

In the parameter collection definition information 403, the parameters 104 that can be collected from the software 103 is defined, but the target software 103 is not designated. In this regard, the parameter collection definition information 403 is associated with the software information 402 as appropriate.

A name of parameter collection, a method of script, a key of a parameter, and a type of a value of a parameter are described in the parameter collection definition information 403. The method of the script indicates whether or not it is a batch (that is, “Windows (registered trademark)”) or a shell script (that is, “Linux (registered trademark)”). The value of the parameter is output to the parameter information XML file 401 as “key and value.”

The discovery script 404 outputs the read parameters 104 to the parameter information XML file 401 (see reference numeral D4).

The parameter information XML file 401 is a file for collecting data collected by the discovery script 404. In the parameter information XML file 401, a parameter which is settable in the software 103 is defined, and content of the parameter collection definition information 403 is included.

In other words, the parameter information XML file 401 is a document which is structured in a markup language. Accordingly, an automatic setting of the parameters 104 for the software 103 can be easily performed.

FIG. 12 is a diagram for describing a process of setting the parameters 104 in the information processing system 100 as an example of an embodiment.

When the deployment request for the software 103 is made by using the same combination of the template 30 and the attached file 302 as one described in the past, the setting of parameters 104 is automated by using the parameters 104 which have been manually set by the operator.

When the deployment request for the software 103 is made by using the same combination of the template 30 and the attached file 302 as one described in the past (see reference numeral E1), the ROR manager 201 (referred to as a “cloud deployment software manager”) performs a predetermined determination. The predetermined determination is not set manually for the parameters 104 of the same software 103 in the past or performed by searching for the parameter setting DB 202 by using the “software 103 and the parameters 104” included in the template 30 as a key.

As a result of search, the ROR manager 201 reads the matched parameter information XML file 401 from the parameter setting DB 202 (see reference numeral E2). The parameter information XML file 401 may be referred to as a setting result of the parameters 104 for each software 103. The process indicated by reference numeral E2 may be referred to as a “pattern matching.”

In other words, the ROR manager 201 corresponds to the determining unit 211 illustrated in FIG. 7.

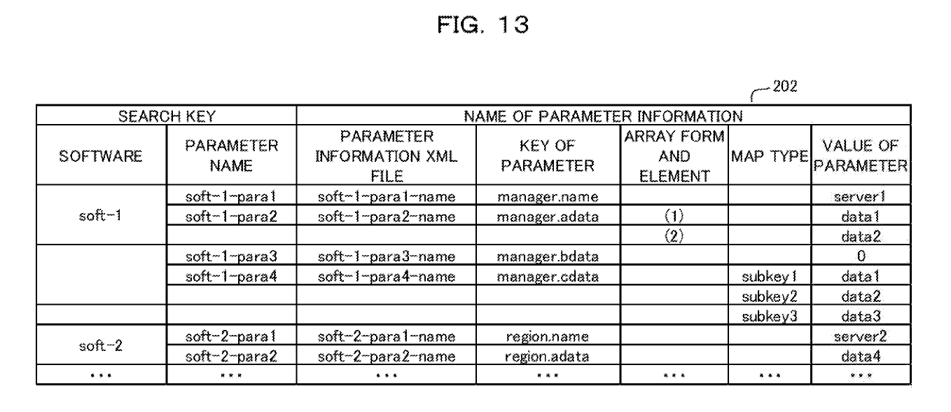

FIG. 13 is a diagram illustrating the parameter setting DB 202 in the information processing system 100 as an example of an embodiment.

The ROR manager 201 searches for and extracts the parameter information XML file 401 corresponding to a search key in the parameter setting DB 202 illustrated in FIG. 13.

In the parameter setting DB 202, the parameter information XML file 401 is accumulated in a format corresponding to the software 103 and the parameters 104 designated by the combination of the template 30 and the attached file 302.

The parameter information XML file 401 read from the parameter setting DB 202 is used as input information of the automatic setting of the parameters 104.

Referring back to FIG. 12, the ROR manager 201 transfers the read parameter information XML file 401 to the ROR agent 105 of the virtual machine 1010 to be newly deployed (that is, referred to as a “cloud deployment software agent”) (refer to reference numeral E3).

Upon receiving the parameter information XML file 401, the ROR agent 105 activates a parameter setting script 107 and inputs the parameter information XML file 401 to the parameter setting script 107 (see reference numeral E4).

Upon receiving the input of the parameter information XML file 401, the parameter setting script 107 sets the parameters 104 to a target software 103 (see reference numeral E5).

In other words, the parameter setting script 107 corresponds to the setting unit 113 illustrated in FIG. 6.

In the software 103 and the parameters 104 designated by the template 30, when the manual setting has not been performed in the past, and the automatic setting process is unable to be performed, the parameters 104 is manually set as described above with reference to FIG. 8.

The operator can determine how far the automatic setting of the parameters 104 has been performed while viewing the parameter management screen of the business server 1.

The parameter setting script 107 receives the parameter information XML file 401 which is a result of the previous parameter manual setting received from the ROR manager 201, and sets the parameters 104 of the target software 103. The parameter setting script 107 sets the parameters 104 of the target software 103 on the basis of the software information 402 and the parameter setting definition information 405.

The parameter setting definition information 405 is a file defining configuration information of the parameter set in the software 103. The parameter setting definition information 405 has content similar to the parameter collection definition information 403 illustrated in FIG. 11.

In the parameter setting definition information 405, the parameters 104 that can be collected from the software 103 are defined, but the target software 103 is not designated. In this regard, the parameter setting definition information 405 is associated with the software information 402 as appropriate.

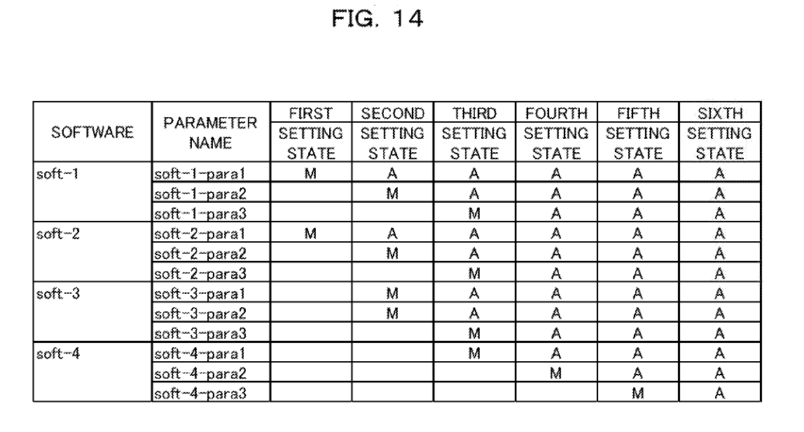

FIG. 14 is a diagram illustrating transition of a setting state of the parameters 104 in the information processing system 100 as an example of an embodiment.

In FIG. 14, “M” indicates a manual setting of the parameters 104 by the operator. Further, In FIG. 14, “A” indicates an automatic setting of the parameters 104 by using the parameter setting DB 202.

In first deployment of the software 103, parameter soft-1-para1 is manually set for software soft-1 by the operator, and parameter soft-2-para1 is manually set for software soft-2 by the operator.

In second deployment of the software 103, parameter soft-1-para2 is manually set for the software soft-1 by the operator, and parameter soft-2-para2 is manually set for the software soft-2 by the operator. Further, parameters soft-3-para1 and soft-3-para2 are manually set for the software soft-3 by the operator.

At this time, the parameter soft-1-para1 is automatically set for the software soft-1 set by the first deployment of the software 103, and the parameter soft-2-para1 is automatically set for the software soft-2.

In third deployment of the software 103, parameter soft-1-para3 is manually set for the software soft-1 by the operator, and parameter soft-2-para3 is manually set for the software soft-2 by the operator. Further, parameter soft-3-para3 is manually set for the software soft-3 by the operator, and parameter soft-4-para1 is manually set for the software soft-4 by the operator.

At this time, the parameters soft-1-para1 and soft-1-para2 are automatically set for the software soft-1 set by the first or second deployment of the software 103, and the parameters soft-2-para1 and soft-2-para2 are automatically set for the software soft-2. Further, the parameters soft-3-para1 and soft-3-para2 are automatically set for the software soft-3 set by the second deployment of the software 103.

By repeating the above process, all the parameters 104 are automatically set as illustrated in a column of sixth deployment of the software 103.

[A-2] Specific Example of Parameter Collection/Setting

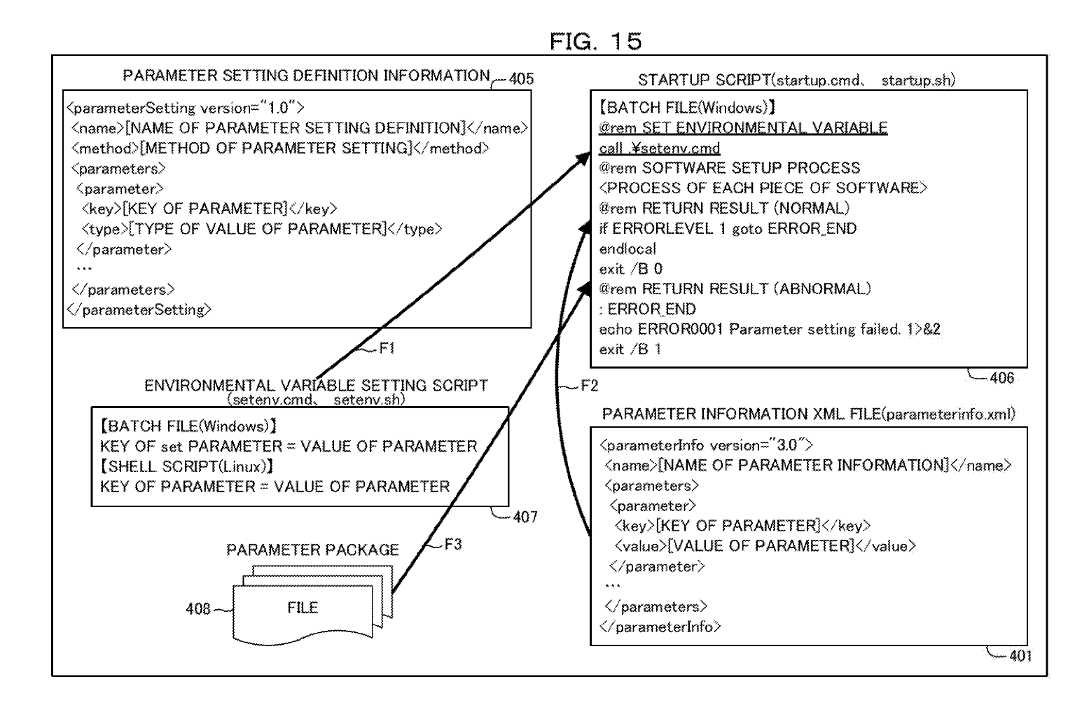

A specific example of collection and setting of the parameters 104 will be described below with reference to FIGS. 15 to 19.

FIG. 15 is a diagram for describing a process of generating a startup script 406 in the information processing system 100 as an example of an embodiment.

In the parameter setting definition information 405, a name of a parameter setting definition, a method of a parameter setting, a key of a parameter and a type of a value of a parameter are described.

The parameter setting script 107 (see FIG. 12) first calls the startup script 406.

For values of the parameters 104, “key and value” are transferred to the startup script 406 through an environmental variable setting script 407 and the parameter information XML file 401 (see reference numerals F1 and F2), and a “file” is transferred through a parameter package 408 (see reference numeral F3).

In order to set the parameters 104, the parameter setting definition information 405 and the parameter setting script 107 (may be referred to as a “script package”) are generated.

In the parameter setting definition information 405, a list of the parameters 104 (may be referred to as “key name, type, and default value”) that can be set in the software 103 is described. The parameter setting definition information 405 includes a software setting ID, and middleware is given a unique ID. For a request for the software setting ID, ROR software setting information is attached and transmitted to a management source.

The parameter setting script 107 is a script for setting the parameters 104 in the software 103. The parameter setting script 107 operates for the target business server 1. In the parameter setting script 107, a batch file is set when the OS 101 is Windows, and a shell script is set when the OS 101 is Linux. The parameter setting script 107 includes the startup script 406 (startup.cmd and setenv.sh), the environmental variable setting script 407 (setenv.cmd and setenv.sh), and the attached file 302.

The startup script 406 is a script called at the beginning of the process of setting the parameters 104. In the process of the script, calling of the environmental variable setting script 407 serving as an input and return of a result serving as an output are performed.

The environmental variable setting script 407 is used for setting of the environmental variable when it is input to the startup script 406. The environmental variable setting script 407 is generated from the parameter information XML file 401 by the ROR agent 105.

As the attached file 302, an arbitrary file can be used in the startup script 406.

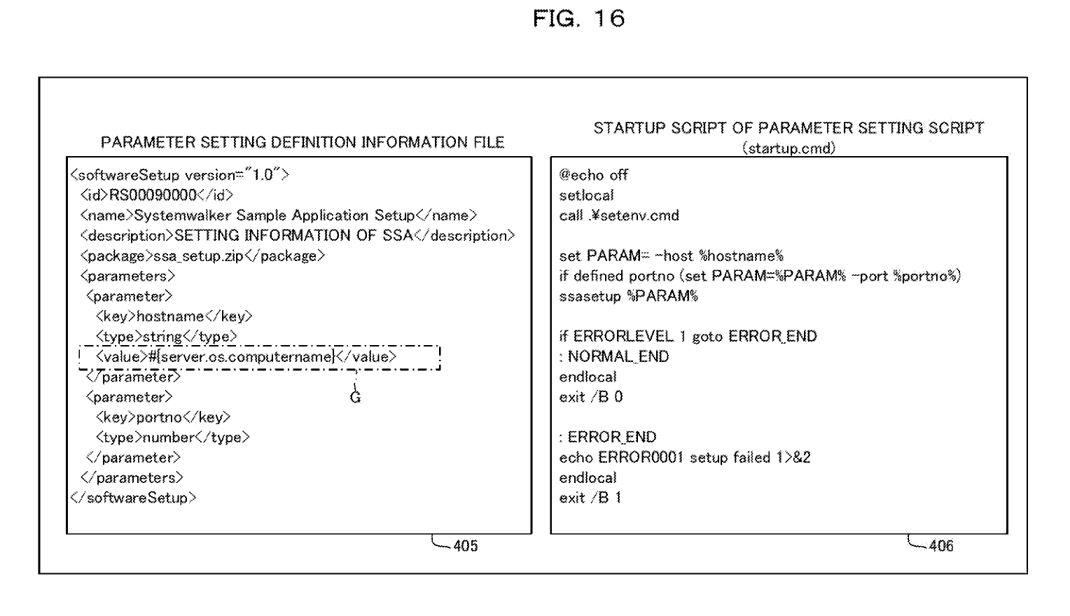

FIG. 16 is a diagram illustrating the parameter setting definition information 405 and the startup script 406 of the parameter setting script 107 in the information processing system 100 as an example of an embodiment.

The parameter setting script 107 (see FIG. 12) sets the parameters 104 of an imaginary product (for example, “systemwalker sample application (SSA)”).

The parameters 104 which are settable in the SSA are a “host name” and a “port number.”

For example, the parameters 104 is set by a management command ssasetup.exe of the SSA in the form of ssasetup-host<host name>-port<port number>.

ssasetup.exe is a command included in the SSA and installed in the SSA.

A developer of middleware provides the parameter setting definition information 405 and the startup script 406 (startup.cmd) of the parameter setting script 107 illustrated in FIG. 16.

In reference numeral G of FIG. 16, in #{sever.os.computername}, a host name is substituted into at the time of the deployment of the virtual machine 1010, and an empty character string is input when a script is generated by a setting script export command.

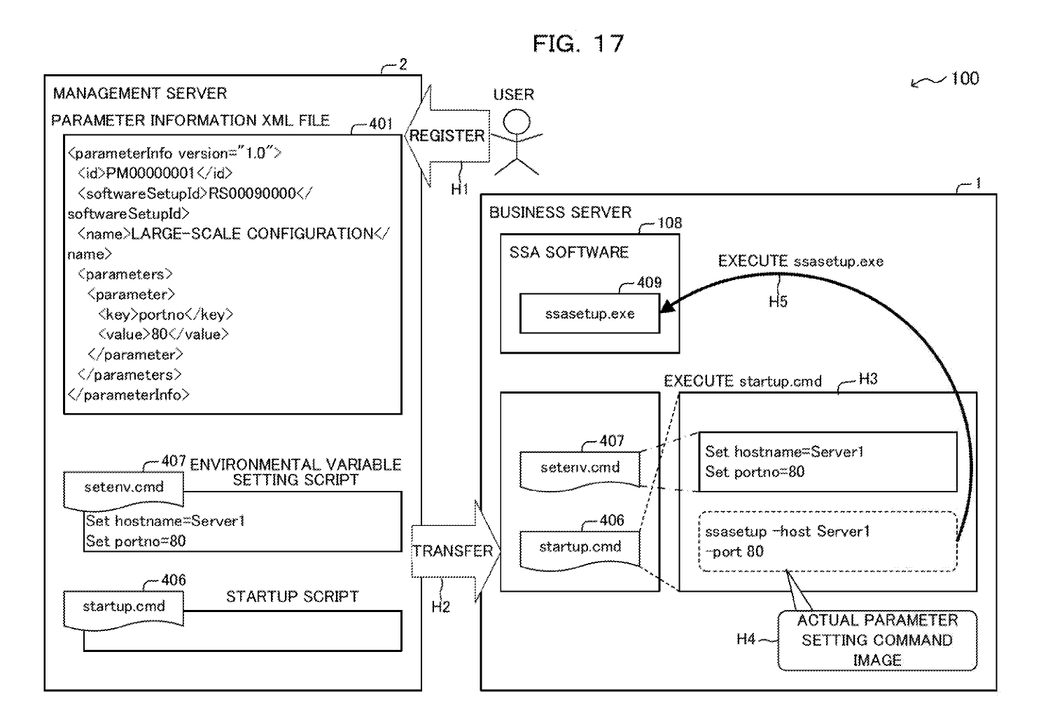

FIG. 17 is a diagram for describing a processing of executing the SSA software in the information processing system 100 as an example of an embodiment.

The user registers the template 30 (see reference numeral H1).

The management server 2 generates the environmental variable setting script 407 on the basis of the parameter information XML file 401 corresponding to the registered template 30.

The management server 2 transfers the environmental variable setting script 407 and the startup script 406 to the target business server 1 (reference numeral H2).

The business server 1 executes the transferred startup script 406 (reference numeral H 3).

An example of an actual command image of a setting of the parameters 104 by execution of the startup script 406 is indicated by reference numeral H4.

Business server 1 executes ssasetup.exe of the SSA (reference numeral H5).

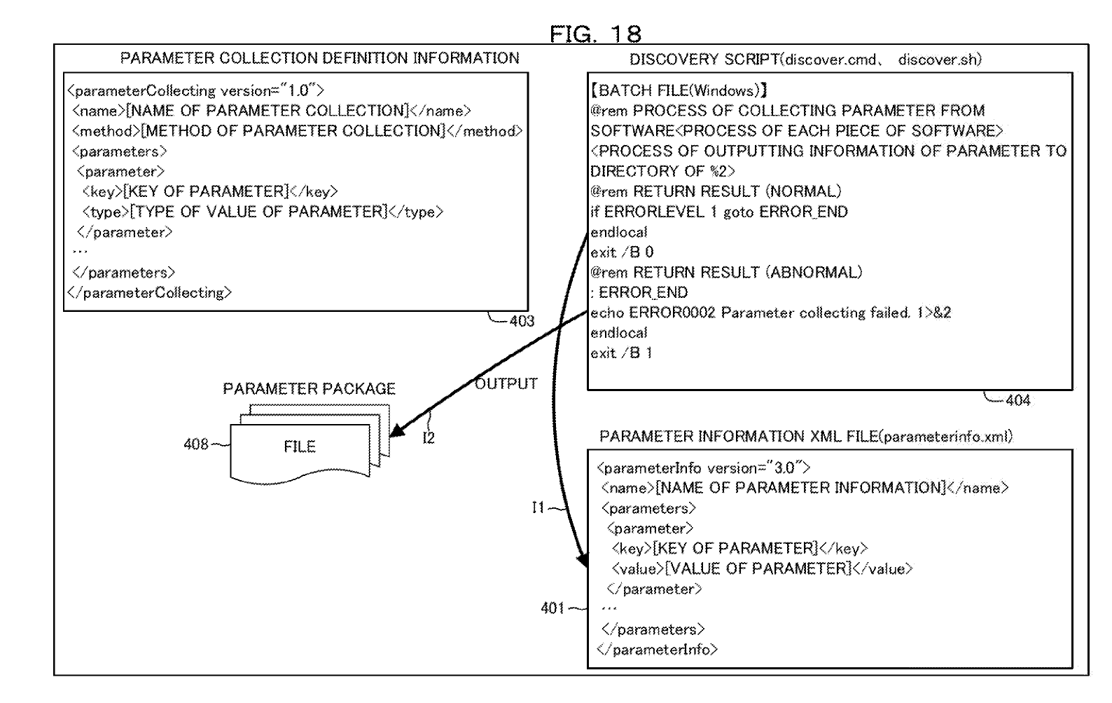

FIG. 18 is a diagram for describing the details of the process of collecting the parameter information XML file 401 in the information processing system 100 as an example of an embodiment.

In the parameter collection definition information 403, a name, a method and parameters (key and type) of parameter collection are described.

The parameter collection script 106 first calls the discovery script 404. For the values of the parameters 104, “key and value” are outputted by the parameter information XML file 401 (see reference numeral I1), and “file” is outputted by the parameter package 408 (see reference numeral I2). The values of the parameters 104 are stored in the parameter setting DB 202.

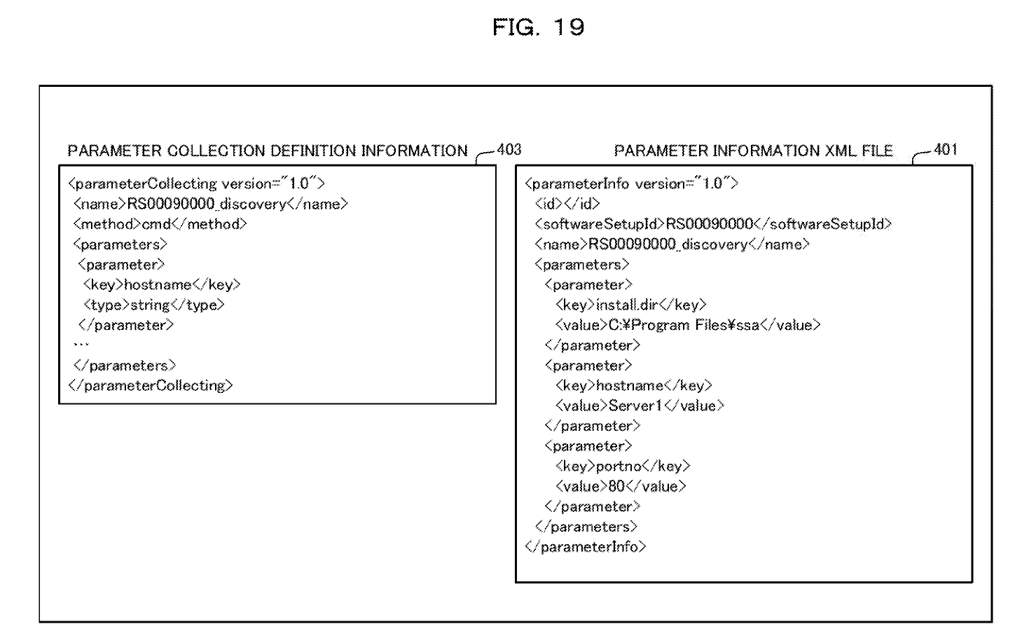

FIG. 19 is a diagram illustrating the parameter collection definition information 403 and the parameter information XML file 401 in the information processing system 100 as an example of an embodiment.

In order to collect the parameters 104, the parameters 104 to be outputted to the parameter information XML file 401 illustrated in FIG. 19 are added to generate the discovery script 404 (discover.cmd and discover.sh).

The discovery script 404 outputs the information of the parameters 104 set in the software 103 to the parameter information XML file 401 on the basis of the parameter collection definition information 403 illustrated in FIG. 19.

### [B] Effects

According to the business server 1 and the information processing system 100 above described in the example of the embodiment, for example, the following effects can be obtained.

It is possible to efficiently deploy the software 103 to the virtual machine 1010. Specifically, it is possible to learn a setting of the parameters 104 which is performed manually when a deployment request is repeatedly transmitted to a plurality of business servers 1 by using the template 30 of the same logical platform in which a clone image of the virtual machine 1010 in which it is desired to be deployed is captured.

The setting of the parameters 104 for the software 103 is automated, and the number of working processes by the operator can be reduced. For example, when the user makes the deployment request by using the template 30 having the clone image of the virtual machine 1010 including monitoring software, works that are dealt with manually such as setting of monitoring parameters of the monitoring software are reduced. Further, when the collection of the parameters 104 is repeatedly performed, the setting of all the parameters 104 can be finally automated.

The automatic setting of the parameters 104 for the software 103 can be easily performed.

According to the information processing apparatus of the disclosure, it is possible to efficiently deploy software to the virtual machine.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus, comprising a processor configured to:
collect software information indicating first software deployed to a virtual machine and a parameter value set in the first software; and
generate parameter information indicating a value which is settable as a parameter of the first software based on the software information and the parameter value which are collected.

2. The information processing apparatus according to claim 1, wherein the processor is further configured to perform a setting of second software to be newly deployed to the virtual machine using the parameter information generated through the generating unit when information indicating the first software and information indicating the parameter coincide with information indicating the second software and information indicating a parameter to be set in the second software, the information indicating the first software and the information indicating the parameter being included in the generated parameter information.

3. The information processing apparatus according to claim 2,
wherein the setting unit performs the setting of the second software based on the software information and the parameter value which are collected.

4. The information processing apparatus according to claim 1,
wherein the generated parameter information is a document structured in a markup language.

5. An information processing system, comprising a processor configured to:
collect software information indicating first software deployed to a virtual machine and a parameter value set in the first software; and
generate parameter information indicating a value which is settable as a parameter of the first software based on the software information and the parameter value which are collected.

6. The information processing system according to claim 5, further comprising,
a storage unit configured to store the generated parameter information,
wherein the processor is further configured to:
determine whether or not information indicating the first software and information indicating the parameter coincide with information indicating second software to be newly deployed to the virtual machine and information indicating a parameter to be set in the second software, the information indicating the first software and the information indicating the parameter being included in the parameter information stored in the storage unit; and
perform the setting of the second software using the parameter information stored in the storage unit when that the information indicating the first software and the information indicating the parameter are determined to coincide with the information indicating the second software and the information indicating the parameter.

7. The information processing system according to claim 6,
wherein the processor is further configured to perform the setting of the second software based on the software information and the parameter value which are collected.

8. The information processing system according to claim 5,
wherein the generated parameter information is a document structured in a markup language.

9. A computer-readable non-transitory recording medium having stored therein a program for causing a computer to execute a process of:
collecting software information indicating first software deployed to a virtual machine and a parameter value set in the first software; and
generating parameter information indicating a value which is settable as a parameter of the first software based on the software information and the parameter value which are collected.

10. The computer-readable non-transitory recording medium according to claim 9,
wherein the program causes the computer to execute a process of performing a setting of second software to be newly deployed to the virtual machine using the generated parameter information when information indicating the first software and information indicating the parameter coincide with information indicating the second software and information indicating a parameter to be set in the second software, the information indicating the first software and the information indicating the parameter being included in the generated parameter information.

11. The computer-readable non-transitory recording medium according to claim 10,
wherein the program causes the computer to execute a process of performing the setting of the second software based on the software information and the parameter value which are collected.

12. The computer-readable non-transitory recording medium according to claim 9,
wherein the generated parameter information is a document structured in a markup language.

13. An information processing method, comprising:
collecting software information indicating first software deployed to a virtual machine and a parameter value set in the first software; and
generating parameter information indicating a value which is settable as a parameter of the first software based on the software information and the parameter value which are collected.

14. The information processing method according to claim 13, further comprising,
storing the generated parameter information;
determining whether or not information indicating the first software and information indicating the parameter coincide with information indicating second software to be newly deployed to the virtual machine and information indicating a parameter to be set in the second software, the information indicating the first software and the information indicating the stored parameter being included in the stored parameter information; and
performing the setting of the second software using the stored parameter information when the information indicating the first software and the information indicating the parameter are determined to coincide with the information indicating the second software and the information indicating the parameter.

15. The information processing method according to claim 14,
wherein the setting of the second software is performed based on the software information and the parameter value which are collected.

16. The information processing method according to claim 13,
wherein the generated parameter information is a document structured in a markup language.
